(19) United States
(12) Patent Application Publication
(10) Pub. No.: US 2026/0128378 A1
(43) Pub. Date: May 7, 2026

(54) Fire Resistant Electrolyte for Lithium Batteries

(71) Applicant: American Hyperform, Inc., Philadelphia, PA (US)

(72) Inventor: William Novis Smith, Philadelphia, PA (US)

(73) Assignee: American Hyperform, Inc., Philadelphia, PA (US)

(21) Appl. No.: 18/938,462

(22) Filed: Nov. 6, 2024

(51) Int. Cl. H01M 10/0569; H01M 10/0525; H01M 10/0568

(52) U.S. Cl. CPC H01M 10/0569; H01M 10/0568; H01M 10/0525; H01M 2300/0037

(57) ABSTRACT

A mixture of bis-(2-methoxyethyl) carbonate (BMC) in a relatively low ratio with the cyclic carbonate EC as the electrolyte solvent in combination with a conductive lithium salt provides the desired electrolyte fire resistance to the resulting electrolyte while maintaining the desired electrolyte conductivity and electrolyte freezing point. The relatively low ratio of BMC to EC used to form the electrolyte solvent is 1:1.5 to 1:19, preferably 1:5.3 to 1:19, and more preferably 1:9 to 1:19, hence 40% to 5%, preferably 19% to 5%, and more preferably 10% to 5%, by weight of BMC to EC. The electrolyte solvent includes a 0.7 to 1.2 Molar, preferably a 0.8 to 1.1 Molar concentration of a lithium hexafluorophosphate salt to form the electrolyte.

### BACKGROUND

Lithium batteries are used in all major applications for rechargeable and many non-rechargeable battery applications including automotive vehicles, mobile electronic devices, uninterruptable power supplies, robotic devices, and others. A rechargeable lithium-ion battery depends on a cathode (positive electrode), an anode (negative electrode), and an electrolyte that transfers ions between the cathode and anode. The cathode generally includes a lithium metal oxide coated onto a metal foil. The anode may contain graphite or silicon coated on a metal foil, generally a copper metal foil, or a lithium metal foil layered or otherwise coated on a substrate, where the substrate is often a metal foil made from copper.

The high flammability of the organic electrolytes conventionally used in lithium batteries is the primary source of the fires reported in association with the failure or physical damage of lithium batteries. Such fires can be especially catastrophic when the lithium batteries are used in the transportation industry, such as in aircraft and automobiles, and when used as a portable power supply for handheld or backpack type electronic devices used in personal, business, and military applications.

During such failure, which may arise from an electrical short, physical rupture of the external case, or other events resulting in a rapid internal temperature increase (exothermic runaway) of the battery, it is the flammable and volatile solvent or solvents used to form the electrolyte that produces the initial fire, and if not already ruptured, ruptures the external case due to the rapid expansion of the volatile solvent/s. Conventionally used electrolyte solvents are volatile and flammable, thus having boiling points at and below 100 degrees Celsius at atmospheric pressure and closed cup flash points around 25 degrees Celsius at atmospheric pressure.

The boiling point of the electrolyte is important to the fire resistance of the battery because in an exothermic runaway condition the temperature inside the external case can reach a temperature of 200 degrees Celsius. The external case, generally made from a hard plastic or metal material, holds the individual battery cell or cells forming the battery.

Electrolytes having a boiling point greater than 200 degrees Celsius at atmospheric pressure subjected to exothermic runaway within the external case of the battery generate significantly less vapor pressure inside the external case and are thus less likely to rupture the case. In addition to reducing the likelihood of external case rupture in response to exothermic runaway, the likelihood of “flash over”, the ignition of additional cells within the external case resulting in fire and catastrophic failure of the battery unit, also is reduced. Additionally, in the circumstance of external case rupture without exothermic runaway, such as from physical impact, the higher the boiling point and closed cup flash point of the electrolyte, the less likely the electrolyte is to ignite from direct ignition by external sources.

To provide the desired electrolyte fire resistance, the solvent or solvent combination used to form the electrolyte should have a boiling point greater than 200 degrees Celsius and a closed cup flash point greater than 105 degrees Celsius, preferably greater than 120 degrees Celsius, at atmospheric pressure. Boiling point and the respective closed cup flash point temperatures of the electrolyte determine the temperature at which the cell separator/s that separate individual battery cell/s within the external case of the battery distort or break, resulting in shorting of the individual battery cells.

However, while maintaining the desired electrolyte fire resistance a lithium battery electrolyte should also have a conductivity of at least 5 mS/cm, preferably of at least 6.5 mS/cm, to provide a desired electrolyte conductivity and thus battery discharge/recharge performance to the lithium battery. Without this desired conductivity, the electrolyte will result in a battery providing poor power delivery and slow recharge ability.

A battery electrolyte should also have a desired electrolyte freezing point of at most +20 degrees Celsius at atmospheric pressure. The freezing point of the electrolyte is important, as if the electrolyte of the battery freezes, the conductivity of the electrolyte will go to zero, rendering the battery useless until self-heating occurs from attempted use and the electrolyte melts.

Conventional attempts to make lithium batteries more fire resistant have generally focused on the addition of organic phosphates, heterocyclic nitrogen compounds, or fluorinated solvents to the conventionally used volatile electrolyte solvents. Other such attempts have focused on reducing the volatility of the conventionally used volatile electrolyte solvents by increasing their viscosity through the addition of gelling agents. Unfortunately, these conventional methods of increasing the fire resistance of the lithium battery by making additions to the conventionally used volatile electrolyte solvents significantly reduce the conductivity of the resulting electrolyte in addition to reducing the flammability.

As an example, conventional electrolytes demonstrating the desired electrolyte boiling point and closed cup flash point generally are overly viscous, thus having poor electrical conductivity of 4 mS/cm or less due to reduced ion transport through the electrolyte with increased electrolyte viscosity. Such conventional electrolytes generally also demonstrate poor solvation of the desired conductive lithium salts, such as lithium hexafluorophosphate (LiPF₆). Hence, the performance of the battery is reduced due to the electrolyte lacking the ability to transport ions at the desired rate for the available electrolyte and cathode volume.

As conventional electrolyte solvent modifications capable of providing the desired electrolyte fire resistance have proven unsuccessful in also providing the necessary electrolyte conductivity, conventional lithium batteries use electrolytes having boiling points from approximately 75 to 105 degrees Celsius and associated closed cup flash points from approximately 20 to 26 degrees Celsius. Thus, the desired electrolyte conductivity is provided by conventional electrolytes, but not the desired electrolyte fire resistance.

A key constituent of a conventional lithium battery electrolyte is ethylene carbonate (EC). EC is important as it forms a necessary protective coating on the carbon-based anode of the battery, thus significantly increasing the number of charge/discharge cycles that the battery can undergo and hence prolonging the life of the battery.

Conventional lithium battery electrolytes generally include at least 15% EC by weight, often 33% EC by weight. EC has a boiling point at atmospheric pressure of 243 degrees Celsius and a closed cup flash point of about 143 degrees Celsius-thus providing the desired electrolyte fire resistance when used as an electrolyte solvent. However, EC has a freezing point of 36 degrees Celsius if used in isolation and thus is a non-electrically conductive solid over the useful temperature range of most batteries and is thus useless as a singular electrolyte material.

To form a conventional electrolyte, EC is combined with one or more volatile electrolyte solvent that is highly volatile in relation to EC to lower the freezing point of the electrolyte, decrease the viscosity of the electrolyte, maximize the conductivity of the electrolyte, and maximize the solubility of the desired conductive lithium salt or salts in the electrolyte, in relation to attempting to use EC in isolation as the electrolyte. Generally, conventional electrolytes include approximately 10% by weight of a conductive lithium salt, with lithium hexafluorophosphate being a preferred conductive lithium salt.

The most common conventional volatile electrolyte solvents are the organic dialkyl carbonates dimethyl carbonate (DMC) (freezing point of minus 4 degrees Celsius), diethyl carbonate (DEC) (freezing point of minus 43 degrees Celsius), and ethyl methyl carbonate (EMC) (freezing point of minus 106 degrees Celsius). Hence, EC is combined with a volatile electrolyte solvent to depress the EC freezing point and to thus maintain the EC in an electrically conductive liquid phase over a wider temperature range.

By combining EC with one or more of these volatile electrolyte solvents, the liquid component of the electrolyte does not freeze until less than-10 degrees Celsius. A conventional ratio of EC to volatile electrolyte solvent is approximately 1:2, with combinations of EC with two volatile electrolyte solvents being common, such as a 1:1:1 ratio of EC:DMC:EMC or EC:DMC:DEC. Such electrolytes also include a conductive lithium salt.

However, from the atmospheric boiling points, these organic solvents are highly volatile and thus highly flammable. For example, DMC has an atmospheric boiling point of 86 degrees Celsius, DEC has an atmospheric boiling point of 126 degrees Celsius, and EMC has an atmospheric boiling point of 106 degrees Celsius. Hence, these volatile electrolyte solvents have boiling points that are about one-half of the desired greater than 200-degree Celsius minimum to provide the desired fire resistance to the electrolyte and thus to the battery.

While electrolytes having a 1:2 ratio of EC to volatile electrolyte solvents including a conductive lithium salt are commonly used in conventional lithium batteries due to their high electrical conductivity of about 10-12 mS/cm, the low boing points result in a closed cup flash point of about 22 degrees Celsius, which means the electrolyte will ignite if exposed to a spark or flame in the air at or above 23 degrees Celsius. Other variations, such as those including a 1:1 combination of 2-methoxyethyl (methyl) carbonate (MMC) with EC have closed cup flash points around 86 degrees Celsius. However, these electrolytes remain significantly below the at least 110-degree Celsius threshold at atmospheric pressure to impart the desired fire resistance to the electrolyte and thus the battery.

The volatile electrolyte solvents also exhibit a vapor pressure exceeding one atmosphere when the battery is heated above 100 degrees Celsius, which can result in pressure rupture of the cell separator/s within the external case of the battery and/or the external case of the battery that holds the cell/s of the battery. If the external case ruptures, the volatile electrolyte solvents will instantaneously ignite as under these conditions the volatile electrolyte solvents are at a temperature significantly above their closed cup flash point. As previously discussed, this situation will result in flash over and ignition of adjacent cells and burning of the lithium battery. Hence, conventional lithium batteries including these volatile electrolyte solvents lack the desired electrolyte fire resistance.

One conventional attempt at replacing at least a portion of the volatile electrolyte solvents involved substituting volatile electrolyte solvent with propylene carbonate (PC), which has a boiling point of 240 degrees Celsius, thus exceeding the 200-degree Celsius desired minimum. However, the PC degrades the graphite carbon anode of the lithium battery during charging and discharging, thus causing an unwanted reduction in battery life. In addition to PC, gamma-butyrolactone, having a boiling point of 206 degrees Celsius, has also been attempted. However, the gamma-butyrolactone degrades at cell voltages of about 4.2 volts and above, so as with PC provides an unacceptable reduction in battery life.

Another conventional attempt as described in U.S. Pat. No. 6,602,976 replaced a portion of the volatile electrolyte solvent component of the electrolyte with low molecular weight liquid oligomers of EC derivatives, specifically dimers and trimers of EC. While providing the desired electrolyte fire resistance to the battery, these electrolytes had conductivities of about 1 mS/cm, thus significantly below the desired electrolyte conductivity of at least 5 mS/cm.

Another conventional attempt as described in U.S. Pat. Nos. 9,034,517 and 8,785,057 used higher boiling point organic carbonates to replace a portion of the volatile electrolyte solvent component of the electrolyte. The described carbonates generally had boiling points around 170 degrees Celsius and above but did not meet the desired minimum of 200 degrees Celsius from a boiling point perspective. The described organic carbonates were also used in combinations of two described carbonates in combination with EC.

As can be seen from the above description, there is an ongoing need for simple and efficient electrolyte solvents that provide the desired electrolyte fire resistance while maintaining the desired electrolyte conductivity and electrolyte freezing point. The materials and methods of the present invention overcome at least one of the disadvantages associated with conventional electrolyte solvents.

### SUMMARY

In one aspect, the invention provides a fire-resistant electrolyte for a lithium battery, the electrolyte comprising: a conductive lithium salt comprising lithium hexafluorophosphate; ethylene carbonate (EC); and bis-(2-methoxyethyl) carbonate (BMC), where the BMC and the EC are in a low weight ratio from 1:1.5 to 1:19, and where the electrolyte has a freezing point of at most +20 degrees Celsius at atmospheric pressure and an electrical conductivity of at least 5 mS/cm at room temperature and pressure (RTP).

In another aspect of the invention, there is a fire-resistant electrolyte for a lithium battery, the electrolyte consisting essentially of: a conductive lithium salt comprising lithium hexafluorophosphate; ethylene carbonate (EC); and bis-(2-methoxyethyl) carbonate (BMC), where the BMC and the EC are in a low weight ratio from 1:1.5 to 1:19.

In another aspect of the invention, there is a rechargeable lithium battery cell, for providing electricity, the lithium battery cell comprising: an anode; a cathode; a separator between the anode and the cathode; and a fire-resistant electrolyte, the electrolyte comprising: a conductive lithium salt comprising lithium hexafluorophosphate; ethylene carbonate (EC); and bis-(2-methoxyethyl) carbonate (BMC), where the BMC and the EC are in a low weight ratio from 1:1.5 to 1:19, and where the electrolyte has a freezing point of at most +20 degrees Celsius at atmospheric pressure and an electrical conductivity of at least 5 mS/cm at room temperature and pressure (RTP).

In another aspect of the invention, there is a rechargeable lithium battery cell, for providing electricity, the lithium battery cell comprising: an anode; a cathode; a separator between the anode and the cathode; and a fire-resistant electrolyte, the electrolyte consisting essentially of: a conductive lithium salt comprising lithium hexafluorophosphate; ethylene carbonate (EC); and bis-(2-methoxyethyl) carbonate (BMC), where the BMC and the EC are in a low weight ratio from 1:1.5 to 1:19.

Other combinations, features, and advantages of the invention will be, or will become, apparent to one with skill in the art upon examination of the following figures and detailed description. It is intended that all such additional combinations, features, and advantages be included within this description, be within the scope of the invention, and be protected by the claims that follow. The scope of the present invention is defined solely by the appended claims and is not affected by the statements within this summary.

### BRIEF DESCRIPTION OF THE FIGURES

The invention can be better understood with reference to the following drawings and description.

FIG. 1 provides charge discharge data for ten cycles for a conventional electrolyte cell and for a cell including the BMC/EC electrolyte and a graphite anode.

FIG. 2 provides charge discharge data for ten cycles for a conventional electrolyte cell and for a cell including the BMC/EC electrolyte and a lithium metal foil anode.

### DETAILED DESCRIPTION

A mixture of bis-(2-methoxyethyl) carbonate (BMC) in a relatively low ratio with the cyclic carbonate EC as the electrolyte solvent in combination with a conductive lithium salt provides the desired electrolyte fire resistance to the resulting electrolyte while maintaining the desired electrolyte conductivity and electrolyte freezing point. The relatively low ratio of BMC to EC used to form the electrolyte solvent is 1:1.5 to 1:19, preferably 1:5.3 to 1:19, and more preferably 1:9 to 1:19, hence 40% to 5%, preferably 19% to 5%, and more preferably 10% to 5%, by weight of BMC to EC. The electrolyte solvent includes a 0.7 to 1.2 Molar, preferably a 0.8 to 1.1 Molar concentration of a lithium hexafluorophosphate salt to form the electrolyte.

The combination of BMC and EC in the relatively low ratio provides an electrolyte solvent boiling point ranging from 226 degrees Celsius to 243 degrees Celsius, preferably from 228 degrees Celsius to 243 degrees Celsius. The combination of BMC and EC in the relatively low ratio provides an electrolyte solvent closed cup flash point ranging from 110 degrees Celsius to 145 degrees Celsius, preferably from 125 degrees Celsius to 143 degrees Celsius. Thus, the combination exceeds the threshold values required to impart the desired electrolyte fire resistance to the battery.

The molecular structure of BMC is H₃COCH₂CH₂OC(═O)OCH₂CH₂OCH₃, thus in relation to the previously discussed relatively large family of organic carbonates, BMC is a specific, symmetric carbonate with a pair of ethoxy ethyl substituents. Unlike the relatively low boiling point of conventional volatile electrolyte solvents, BMC has a boiling point of 225 degrees Celsius and a closed cup flash point of 125 degrees Celsius, which approximates the 243-degree boiling point and 143-degree closed cup flash point of EC.

Additionally, BMC has a freezing point below −60 degrees Celsius and when combined with EC (freezing point 36 degrees Celsius) in the relatively low ratios unpredictably provides an electrolyte having a freezing point of at most +20 degrees Celsius. It would be predicted that at a minimum a larger amount BMC would be required and more likely also a relatively large amount of a volatile electrolyte solvent to provide a freezing point in this range as is common for the approximate 1:1:1 solvent blends conventionally used and previously discussed.

Hence, the BMC/EC combination at the relatively low ratios effectively eliminates the freezing/solidification issues typically encountered at relatively cold ambient temperatures in devices which contain electrolytes based on EC as the primary solvent without the need for larger amounts of BMC or a volatile electrolyte solvent. Hence, in addition to providing the desired electrolyte fire resistance to the battery, the BMC/EC combination at the relatively low ratio provides a desired electrolyte freezing point to the battery.

Also unexpectedly, the BMC/EC combination at the relatively low ratios provides an electrical conductivity of at least 5 mS/cm, preferably of at least 6.5 mS/cm, thus only 15% below that of EC in isolation. An added benefit contributing to the conductivity performance of the BMC/EC combination at the relatively low ratios is that in relation to other carbonates, BMC does not materially increase the viscosity over EC/carbonate electrolytes over the normal operating temperature range of the battery. Hence, in addition to providing the desired electrolyte fire resistance and the desired electrolyte freezing point to the battery, the BMC/EC combination unpredictably provides a desired electrolyte conductivity to the battery. It would not have been predicted that the relatively low ratio of BMC to EC could provide a desired freezing point reduction in relation to the EC freezing point of EC while maintaining a desired conductivity.

When BMC and EC are combined in the relatively low ratio, a solution is formed that can further solvate conductive lithium salts. Preferable conductive lithium salts may be chosen from lithium hexafluorophosphate, lithium bis-fluorosulfonyl imide, lithium bis-trifluoromethyl sulfonate imide, lithium perchlorate, lithium trifluoromethyl sulfonate, and lithium tetrafluoroborate. Preferably, the conductive lithium salt is primarily lithium hexafluorophosphate with smaller concentrations (up to 0.6 Molar) of a second conductive lithium salt such as lithium bis-fluorosulfonyl imide, lithium bis-trifluoromethyl sulfonate imide, lithium perchlorate, lithium trifluoromethyl sulfonate, and/or lithium tetrafluoroborate. Preferably, lithium hexafluorophosphate is solvated into the electrolyte solution to provide a 0.7 to 1.2 Molar, more preferably a 0.8 to 1.1 Molar, concentration of the lithium hexafluorophosphate salt in the solution. The resulting solution is the electrolyte for a lithium battery.

While less preferred, other solvents may be added in minor amounts to the BMC/EC combination, thus reducing the EC content of the electrolyte solvent solution. However, such other solvents are only added in minor amounts that do not materially alter the desired boiling point, flash point, freezing point, and conductivity ranges as previously discussed. Thus, any additional electrolyte component other than BMC/EC and the conductive lithium salt present in the electrolyte is not present in an amount that materially alters the desired boiling point, flash point, freezing point, and conductivity ranges as previously discussed. Preferably, the electrolyte is substantially free of added solvents other than the BMC/EC combination. More preferably, the electrolyte does not include a volatile electrolyte solvent in a percentage greater than 5% by weight of the electrolyte. Most preferably, the electrolyte does not include a volatile electrolyte solvent.

Because the described BMC/EC combination provides the desired electrolyte fire resistance to the battery, it can effectively eliminate many lithium battery fires where the batteries include graphite anodes, silicon anodes, and lithium metal anodes. From a use perspective, once the battery is turned on the temperature within the external case of the battery increases to about +38 degrees Celsius, thus establishing the sufficiency of the at most +20 degrees Celsius freezing point provided by the BMC/EC combination electrolyte. As an added benefit, at approximately 38 degrees Celsius the at least 5 mS/cm conductivity provided by the electrolyte will approach 10 mS/cm, hence, substantially enhancing the electrical performance of the battery.

A lithium battery including the BMC/EC electrolyte combination is formed by placing a thin separator of polypropylene, polyethylene, or a mixture of these or other inert polymer materials between an anode and a cathode to form a cell. Several alternating layers of these cells can be stacked and then inserted into a cell pouch serving as a cell separator or in a cylindrical or other shaped external case if a single cell battery. The electrolyte may then be added to the cells, preferably under an inert atmosphere, and sealed into the pouch or external case with two separate protruding electrodes, a positive cathode and a negative anode, to form the lithium battery. The lithium battery then may be connected to an initial charge/discharge cycle for the initial formation charge step to prepare the battery for service and to complete the process of forming a new lithium battery.

Lithium batteries including the BMC/EC electrolyte combination function safely and dependably as high temperature use lithium batteries where temperatures inside the external case of the battery range from 50 to 100 degrees Celsius. Many applications exist where such internal battery temperatures are common and where the significantly improved fire resistance in relation to conventional electrolyte batteries would be beneficial and necessary.

The following examples illustrate one or more preferred embodiments of the invention. Numerous variations may be made to the following examples that lie within the scope of the invention.

### EXAMPLES

### Example 1: Preparation of Bis-(2-Methoxyethyl) Carbonate (BMC)

Into a 3-L, 3-necked flask were added 1081 g (12 moles) of dimethyl carbonate (DMC), 1522 g (20.0 moles) 2-methoxy ethanol, and 100 g of a 25% sodium methoxide in methanol solution. A 250° C. thermometer along with a stirrer were fitted to the flask. A distilling head and condenser were added to the remaining neck of the flask. The flask was purged with nitrogen and then stirred for 30 minutes until a cloudy suspension formed. The flask was then heated from about 65° C. to 75° C. while stirring under nitrogen to distill off the methanol formed from the transesterification. The temperature of the flask was then raised to 125° C. to remove traces of dimethyl carbonate and was then cooled under nitrogen. The reaction mixture was mixed with 100 g NaH₂PO₄ to neutralize the sodium methoxide; the slurry was filtered, and the clear liquid filtrate distilled under vacuum. The yield was 1602 g of colorless bis-(2-methoxyethyl) carbonate, (BMC).

### Example 2: Preparation of Electrolyte Solutions

The distilled BMC obtained in accordance with Example 1 was mixed under nitrogen with the ethylene carbonate in weight ratios ranging from 30% EC to 98% EC with the balance being the BMC (i.e., 70% BMC to 2% BMC). The mixture was stirred until a solution formed from the two liquids.

Closed cup flash point and boiling point testing was performed on this solution. Closed cup flash points were determined with a commercial Gardner closed cup flash point unit with a ramp rate of one minute/degree Celsius as obtained from Gardner Products, Horicon, Wisconsin. Boiling points were obtained by distillation of the product under vacuum and then extrapolated to obtain an atmospheric pressure boiling point.

Then LiPF₆ was added under nitrogen while stirring to the BMC/EC liquid and the resulting mixture was stirred until solvation of the solid LiPF₆.

The resulting electrolyte was analyzed by Karl Fisher titration for water content and stored under nitrogen in a dry box. Freezing point determination of the electrolyte was determined by adding the electrolyte into standard capillary freezing point tubes and lowering the temperature of the tubes in a cooling bath at the rate of one degree Celsius per minute. The freezing point was determined by an opacity change in the transparency of the tube contents. The tube was then cooled slightly lower than the freezing point and then warmed at a one degree Celsius per minute rate to determine the melting point. The freezing and melting point values agreed within a degree Celsius.

Conductivity determination of the electrolyte was determined by placing the electrolyte in a closed flask under nitrogen with the insertion of a conductivity probe from a Fisher conductivity meter. After approximately 10 minutes the conductivity reading stabilized and was thus determined. From testing multiple electrolyte preparations having different BMC to EC ratios at different conductive lithium salt concentrations, the following table was assembled from measured, reference, and interpolated data.

TABLE I

| | CC Flash | Boiling | Freeze | |
|---|---|---|---|---|
| BMC/EC Conc | Point | Range | Point | Conductivity |
| Weight % | Degrees C. | Degrees C. | Degrees C. | mS/cm |
| 40% BMC | 110 | 226-243 | −8 | 5.5 |
| 25% BMC | 120 | 226-243 | +9 | 6.4 |
| 19% BMC | 125 | 226-243 | +10 | 6.5 |
| 10% BMC | 145 | 228-243 | +16 | ~7 |
| 5% BMC | 145 | 230-243 | +19 | 8 |
| 2% BMC | 145 | 242-243 | +30 | 8 |

At the lower BMC concentration, the 2% BMC 98% EC combination provided no meaningful increase in electrolyte conductivity for the undesirable nearly 10-degree Celsius increase in freezing point. This surprising increase in freezing point was unexpected in view of the only 3% change in BMC concentration. It is expected that some alteration of the solvation interaction between the BC and EC shifts at this concentration range.

Regarding the upper BMC concentration, at the 40% BMC to 60% EC combination, the closed cup flash point unexpectedly started to advantageously increase at an increasing rate, hence providing an unpredicted benefit to the BMC/EC combination at this ratio. The 19% BMC 81% EC combination provided a highly desired 125 degree and greater Celsius closed cup flash point in combination with the desired higher conductivity and a sufficient lowering of the freezing point.

### Example 3: Battery Cell Preparation

Lithium nickel manganese cobalt (NMC) spinel cathodes, graphite anodes, and lithium foil anodes were obtained commercially from NEI Corporation, Somerset NJ, and cut to fit 2″×3″ commercially available vacuum pouch cells. Commercial vacuum pouch cells also were obtained from NEI Corporation. The electrodes were placed within the vacuum pouch cells. The cells were dried prior to filling with a BMC/EC electrolyte solution as generally described in Example 2 or a conventional electrolyte including a 1:1:1 mixture of EC/DMC/EMC with a 1 Molar concentration of LiPF₆. The cells were then pressed to eliminate any excess electrolyte and sealed under vacuum.

The cells were subjected to a formation cycle, and charge/discharge cycle testing was then performed with a Maccor testing unit as available from Maccor, 4322 South 49th W Ave, Tulsa, OK 74107 USA. Both the conventional EC/DMC/EMC electrolyte cell and the cell including the BMC/EC electrolyte showed good stability through at least 10 charge/discharge cycles for both the carbon and lithium foil anodes.

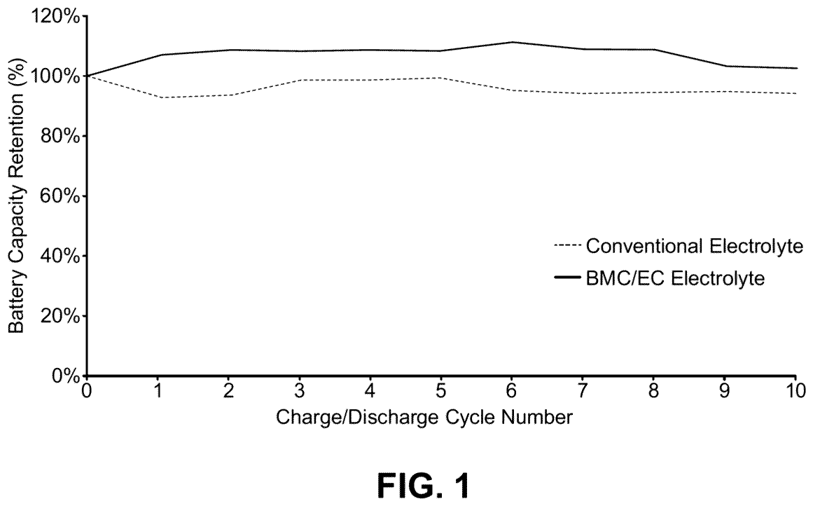

FIG. 1 provides charge discharge data for ten cycles for a conventional electrolyte cell and for a cell including the BMC/EC combination electrolyte and a graphite anode. As reflected in the figure, the cell including the BMC/EC electrolyte showed better stability during the ten charge/discharge cycles than the conventional EC/DMC/EMC electrolyte.

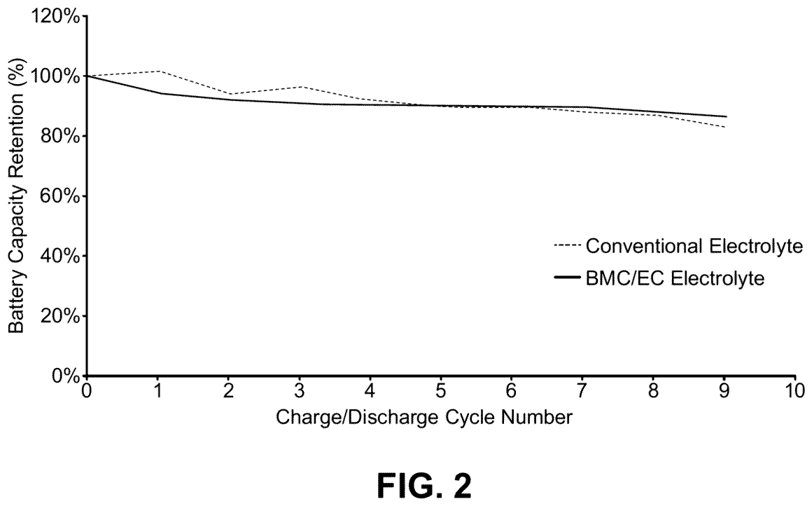

FIG. 2 provides charge discharge data for ten cycles for a conventional electrolyte cell and for a cell including the BMC/EC combination electrolyte and a lithium metal foil anode. As reflected in the figure, the cell including the BMC/EC electrolyte showed better stability during the ten charge/discharge cycles than the conventional EC/DMC/EMC electrolyte.

As the first 10 charge and discharge cycles of the BMC/EC combination electrolyte batteries showed no decrease in output after recharging indicating that both battery types will successfully undergo long recharging cycles-thus providing a long battery life.

To provide a clear and more consistent understanding of the specification and claims of this application, the following definitions are provided.

The terms “a”, “an”, and “the” used in the specification claims are to be construed to cover both the singular and the plural, unless otherwise indicated or contradicted by context. No language in the specification should be construed as indicating any non-claimed element to be essential to the practice of the invention.

Closed cup flash point means the lowest liquid temperature at which a liquid gives off vapor in a quantity sufficient to form an ignitable vapor/air mixture. In such a measurement the liquid is placed in a cup with a sealed lid through which an ignition source can be introduced. The temperature of the liquid within the closed cup is exposed to the ignition source and the temperature of the liquid slowly increased until the vapor ignites. Closed cup flash point testing was conducted by the Small Scale closed cup method (equilibrial) as detailed in ASTM D3828 and D3278. Either one of these methods may be chosen to provide the closed cup flash point.

Unless otherwise indicated, all numbers expressing quantities and ratios of ingredients, and the like used in the specification and claims are to be understood as indicating both the exact values as shown and as being modified by the term “about”. Thus, unless indicated to the contrary, the numerical values of the specification and claims are approximations that may vary depending on the desired properties sought to be obtained and the margin of error in determining the values. At the very least, and not as an attempt to limit the application of the doctrine of equivalents to the scope of the claims, each numerical parameter should at least be construed considering the margin of error, the number of reported significant digits, and by applying ordinary rounding techniques.

Unless the context clearly dictates otherwise, where a range of values is provided, each intervening value to the tenth of the unit of the lower limit between the lower limit and the upper limit of the range is included in the range of values.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the description and claims are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

The described methods can be performed in any suitable order unless otherwise indicated or contradicted by context.

Room temperature and pressure (RTP) means from 20 to 25 degrees Celsius at approximately 100 kPa.

Solid means a substance that is not a liquid or a gas at room temperature and pressure. A solid substance may have one of a variety of forms, including a monolithic solid, a powder, a gel, or a paste.

Liquid means a substance that is not a solid or a gas at room temperature and pressure. A liquid is an incompressible substance that flows to take on the shape of its container.

Solutions lack an identifiable interface between the solubilized molecules and the solvent. In solutions, the solubilized molecules are in direct contact with the solvent.

Substantially free of added refers to the electrolyte being free from an amount of a volatile electrolyte solvent that materially alters the desired boiling point, flash point, freezing point, and conductivity ranges as previously specified, but where the composition may include trace amounts of additional solvents.

While various aspects of the invention are described, it will be apparent to those of ordinary skill in the art that other embodiments and implementations are possible within the scope of the invention. Accordingly, the invention is not to be restricted except in light of the attached claims and their equivalents.

1. A fire-resistant electrolyte for a lithium battery, the electrolyte comprising:
a conductive lithium salt chosen from lithium hexafluorophosphate, lithium bis-fluorosulfonyl imide, and combinations thereof;
ethylene carbonate (EC); and
bis-(2-methoxyethyl) carbonate (BMC), where
the BMC and the EC are in a low weight ratio from 1:5.3 to 1:19, where
the electrolyte has an electrical conductivity of at least 5 mS/cm at room temperature and pressure (RTP), and where
the electrolyte has a boiling point of greater than 200 degrees Celsius at atmospheric pressure.

2. The electrolyte of claim 1, where the electrolyte has a closed cup flash point greater than 105 degrees Celsius at RTP.

3. The electrolyte of claim 2, where the electrolyte has a boiling point of at least 226 degrees Celsius at RTP.

4. The electrolyte of claim 2, where the electrolyte has a closed cup flash point greater than 120 degrees Celsius at RTP.

5. The electrolyte of claim 2, where the electrolyte has a closed cup flash point from 125 to 145 degrees Celsius at RTP.

6. The electrolyte of claim 1, where the electrolyte has a conductivity of at least 6.5 mS/cm.

7. (canceled)

8. The electrolyte of claim 1, where the low weight ratio is from 1:9 to 1:19.

9. The electrolyte of claim 1, where the lithium hexafluorophosphate is present in the electrolyte at a 0.7 to 1.2 Molar concentration.

10. The electrolyte of claim 1, where the lithium hexafluorophosphate is present in the electrolyte at a 0.8 to 1.1 Molar concentration.

11. The electrolyte of claim 1, further comprising a second conductive lithium salt present in the electrolyte at up to a 0.6 Molar concentration.

12. The electrolyte of claim 11, where the second conductive lithium salt is chosen from lithium bis-fluorosulfonyl imide, lithium bis-trifluoromethyl sulfonate imide, lithium perchlorate, lithium trifluoromethyl sulfonate, and lithium tetrafluoroborate.

13. The electrolyte of claim 1, where the electrolyte is substantially free of a volatile electrolyte solvent.

14. A fire-resistant electrolyte for a lithium battery, the electrolyte consisting essentially of:
a conductive lithium salt comprising lithium hexafluorophosphate;
ethylene carbonate (EC); and
bis-(2-methoxyethyl) carbonate (BMC), where
the BMC and the EC are in a low weight ratio from 1:1.5 to 1:19,
the electrolyte has an electrical conductivity of at least 5 mS/cm at room temperature and pressure (RTP), and
the electrolyte has a boiling point of greater than 200 degrees Celsius at atmospheric pressure.

15. The electrolyte of claim 14, where the low weight ratio is from 1:5.3 to 1:19.

16. The electrolyte of claim 14, where the low weight ratio is from 1:9 to 1:19.

17. The electrolyte of claim 14, where the lithium hexafluorophosphate is present in the electrolyte at a 0.7 to 1.2 Molar concentration.

18. The electrolyte of claim 14, where the lithium hexafluorophosphate is present in the electrolyte at a 0.8 to 1.1 Molar concentration.

19. The electrolyte of claim 14, further comprising a second conductive lithium salt present in the electrolyte at up to a 0.6 Molar concentration.

20. The electrolyte of claim 19, where the second conductive lithium salt is chosen from lithium bis-fluorosulfonyl imide, lithium bis-trifluoromethyl sulfonate imide, lithium perchlorate, lithium trifluoromethyl sulfonate, and lithium tetrafluoroborate.

21. The electrolyte of claim 14, where the electrolyte is substantially free of a volatile electrolyte solvent.

22. A rechargeable lithium battery cell, for providing electricity, the lithium battery cell comprising:
an anode;
a cathode;
a separator between the anode and the cathode; and
a fire-resistant electrolyte, the electrolyte comprising:
a conductive lithium salt comprising lithium hexafluorophosphate;
ethylene carbonate (EC); and
bis-(2-methoxyethyl) carbonate (BMC), where
the BMC and the EC are in a low weight ratio from 1:5.3 to 1:194:3 to 1:49, where
the electrolyte has an electrical conductivity of at least 5 mS/cm at room temperature and pressure (RTP), and where
the electrolyte has a boiling point of greater than 200 degrees Celsius at atmospheric pressure.

23.-38. (canceled)

39. A rechargeable lithium battery cell, for providing electricity, the lithium battery cell comprising:
an anode;
a cathode;
a separator between the anode and the cathode; and
a fire-resistant electrolyte, the electrolyte consisting essentially of:
a conductive lithium salt comprising lithium hexafluorophosphate;
ethylene carbonate (EC); and
bis-(2-methoxyethyl) carbonate (BMC), where
the BMC and the EC are in a low weight ratio from 1:1.5 to 1:19,
the electrolyte has an electrical conductivity of at least 5 mS/cm at room temperature and pressure (RTP), and
the electrolyte has a boiling point of greater than 200 degrees Celsius at atmospheric pressure.

40.-50. (canceled)

51. The cell of claim 22, where the separator is a polymer material chosen from polypropylene and polyethylene.

52. The cell of claim 22, further comprising:
an external case enclosing the anode, the cathode, and the separator;
a positive terminal extending exterior to the external case in electrical communication with the cathode; and
a negative terminal extending exterior the external case in electrical communication with the anode.

53. The cell of claim 52, where the cell forms a rechargeable lithium battery.

54. The cell of claim 52 further comprising at least one additional cell to form a rechargeable lithium battery having more than one cell.

55. The cell of claim 22, where the electrolyte has a closed cup flash point greater than 105 degrees Celsius at RTP.

56. The cell of claim 55, where the electrolyte has a boiling point of at least 226 degrees Celsius at RTP.

57. The cell of claim 55, where the electrolyte has a closed cup flash point greater than 120 degrees Celsius at RTP.

58. The cell of claim 55, where the electrolyte has a closed cup flash point from 125 to 145 degrees Celsius at RTP.

59. The cell of claim 22, where the electrolyte has a conductivity of at least 6.5 mS/cm.

60. (canceled)

61. The cell of claim 22, where the low weight ratio is from 1:9 to 1:19.

62. The cell of claim 22, where the lithium hexafluorophosphate is present in the electrolyte at a 0.7 to 1.2 Molar concentration.

63. The cell of claim 22, where the lithium hexafluorophosphate is present in the electrolyte at a 0.8 to 1.1 Molar concentration.

64. The cell of claim 22, further comprising a second conductive lithium salt present in the electrolyte at up to a 0.6 Molar concentration.

65. The cell of claim 64, where the second conductive lithium salt is chosen from lithium bis-fluorosulfonyl imide, lithium bis-trifluoromethyl sulfonate imide, lithium perchlorate, lithium trifluoromethyl sulfonate, and lithium tetrafluoroborate.

66. The cell of claim 22, where the electrolyte is substantially free of a volatile electrolyte solvent.

67. The cell of claim 39, where the separator is a polymer material chosen from polypropylene and polyethylene.

68. The cell of claim 39, further comprising:
an external case enclosing the anode, the cathode, and the separator;
a positive terminal extending exterior to the external case in electrical communication with the cathode; and
a negative terminal extending exterior the external case in electrical communication with the anode.

69. The cell of claim 68, where the cell forms a rechargeable lithium battery.

70. The cell of claim 68 further comprising at least one additional cell to form a rechargeable lithium battery having more than one cell.

71. The cell of claim 39, where the low weight ratio is from 1:9 to 1:19.

72. The cell of claim 39, where the lithium hexafluorophosphate is present in the electrolyte at a 0.7 to 1.2 Molar concentration.

73. The cell of claim 39, where the lithium hexafluorophosphate is present in the electrolyte at a 0.8 to 1.1 Molar concentration.

74. The cell of claim 39, further comprising a second conductive lithium salt present in the electrolyte at up to a 0.6 Molar concentration.

75. The cell of claim 74, where the second conductive lithium salt is chosen from lithium bis-fluorosulfonyl imide, lithium bis-trifluoromethyl sulfonate imide, lithium perchlorate, lithium trifluoromethyl sulfonate, and lithium tetrafluoroborate.

76. The cell of claim 39, where the electrolyte is substantially free of a volatile electrolyte solvent.

77. The cell of claim 39, where the low weight ratio is from 1:5.3 to 1:19.

78. The electrolyte of claim 1, where the electrolyte has a freezing point of at most +20 degrees Celsius at atmospheric pressure.

79. The cell of claim 22, where the electrolyte has a freezing point of at most +20 degrees Celsius at atmospheric pressure.
